(19) United States
(12) Patent Application Publication
(10) Pub. No.: US 2024/0327673 A1
(43) Pub. Date: Oct. 3, 2024

(54) COMPOUND COMPOSITE FOR PROTECTING FILM FOR VEHICLE

(71) Applicant: STEK CO., LTD., Seoul (KR)

(72) Inventors: Beckyoun Noh, Seongnam-si (KR); Inhwan Oh, Seoul (KR)

(21) Appl. No.: 18/137,001

(22) Filed: Apr. 20, 2023

(30) Foreign Application Priority Data
Mar. 30, 2023 (KR) 10-2023-0042105

(51) Int. Cl. C09G 1/02; B24B 57/02

(52) U.S. Cl. CPC C09G 1/02; B24B 57/02

(57) ABSTRACT

The present invention relates to a compound composite for restoring a protecting film for a vehicle, and more particularly, to a compound composite for restoring a protecting film for a vehicle, in which a lubricant having an evaporation point of 150° C. or higher is added to evaporate the compound composition at an appropriate rate during polishing work, so that the protecting film for the vehicle is restored without a damage.

### BACKGROUND OF THE INVENTION

### 1. Field of the Invention

The present invention relates to a compound composite for restoring a protecting film for a vehicle, and more particularly, to a compound composite for restoring a protecting film for a vehicle, in which a lubricant having an evaporation point of 150° C. or higher is added to evaporate the compound composition at an appropriate rate during polishing work, so that the protecting film for the vehicle is restored without a damage.

### 2. Description of the Related Art

Expensive vehicles need relatively meticulous maintenance, and most vehicles have a vehicle protecting film attached thereto. The vehicle protecting film may correspond to a wrapping film, PPF, or the like.

Since the vehicle protecting film has a relatively short history compared to vehicle painting and is only used in some vehicles, there is a lack of solutions for managing the vehicle protecting film. Accordingly, when damages such as water spots or scratches are generated on the vehicle protecting film, the damaged vehicle protecting film is removed and then re-installed. However, this causes the problem in that the installation cost for the vehicle protecting film may amount to several million Korean Won to tens of thousands of Korean Won, thereby returning to the burden of a consumer.

Recently, in order to improve the above problem, schemes of applying a compound onto a surface of a damaged vehicle protecting film and polishing the surface by using a pad have been attempted. However, the vehicle protecting film has a surface friction relatively high compared to a painted surface of the vehicle, so a lot of heat is generated during polishing work, and the vehicle protecting film is formed of a constituent material, such as TPU, which is vulnerable to heat compared to the painted surface of the vehicle, and thus the surface of the vehicle protecting film is burned or damaged due to the vulnerability to heat.

In addition, when a surface layer of the vehicle protecting film is a clear coat, and when polishing is repeatedly performed using a compound, the clear coat may be weakened to lower UV blocking performance, resulting in discoloration, or a base coat positioned on a lower side of the clear coat may be exposed to the outside and damaged.

In other words, there is an urgent need to develop a compound composition for restoring the surface of a vehicle protecting film to a state before the damage without damaging the vehicle protecting film and without rebuilding entirely or partially.

### SUMMARY OF THE INVENTION

An object of the present invention is to provide a compound composite for restoring a protecting film for a vehicle, in which a lubricant having an evaporation point of 150° C. or higher is added to evaporate the compound composition at an appropriate rate during polishing work, so that the protecting film for the vehicle is restored without a damage.

In order to solve the above problem, one embodiment of the present invention provides a compound composite for restoring a protecting film for a vehicle, which includes: an abrasive containing metal oxide powder; a lubricant having an evaporation point of 150° C. or higher; and a solvent containing water, wherein, when the vehicle protecting film includes a self-restoration layer in which a damage is generated on an upper side of the vehicle protecting film, the compound composition is applied to the self-restoration layer and then the upper side of the self-restoration layer is polished using a pad by a predetermined thickness, thereby removing the damage.

In some embodiments of the invention, the abrasive may include, based on ANSI (Grit) standards, a first abrasive having a particle size of 1400 grits to 2800 grits or a particle size of 4000 grits to 6000 grits; and a second abrasive having a particle size of 2800 grits to 3350 grits.

In some embodiments of the invention, the lubricant may include: a first lubricant having an evaporation point of 150° C. or higher; and a second lubricant having an evaporation point equal to or higher than the evaporation point of the first lubricant.

In some embodiments of the invention, the second lubricant may have an evaporation point of 150° C. to 400° C.

In some embodiments of the invention, the metal oxide powder may include any one of aluminum oxide and silicon carbide.

In some embodiments of the invention, the compound composition may include 10 wt % to 20 wt % of an abrasive, 15 wt % to 25 wt % of a lubricant, and 45 wt % to 55 wt % of a solvent, based on a total weight.

One embodiment of the present invention may provide a compound composite for restoring a protecting film for a vehicle, in which a lubricant having an evaporation point of 150° C. or higher is added to evaporate the compound composition at an appropriate rate during polishing work, so that the vehicle protecting film for a vehicle can be restored without a damage.

According to one embodiment of the present invention, water is used as a solvent for the compound composition in considering that the surface temperature of the vehicle protecting film during polishing work is about 90° C., so that the compound composition can be evaporated at an appropriate rate during the polishing work.

According to one embodiment of the present invention, a lubricant having an evaporation point of 150° C. or higher is added to the compound composition, and accordingly, the compound composition may remain on the surface of the vehicle protecting film even during polishing work, so that the surface of the vehicle protecting film can be prevented from being damaged.

According to one embodiment of the present invention, the compound composition includes an abrasive having a specific particle size to evenly polish the surface of the vehicle protecting film, so that the completion of the polishing work can be improved.

According to one embodiment of the present invention, a combination of a first lubricant having an oil evaporation point of 150° C. and a lubricant having an oil evaporation point of 250° C. is added to the compound composition, so that the vehicle protecting film can be more effectively restored.

According to one embodiment of the present invention, the compound composition includes a second lubricant having an oil evaporation point of 200° C. or higher so as to be used stably even when being left in heat generated for a long time during the polishing work, so that the vehicle protecting film can be managed, such as polishing, without a damage on the surface.

### BRIEF DESCRIPTION OF THE DRAWINGS

FIGS. 1A, 1B and 1C show states in which damages occur to a vehicle protecting film as an example.

FIGS. 2A and 2B schematically show states in which the vehicle protecting film is polished using a conventional compound.

FIGS. 3A, 3B and 3C conceptually show a restoration solution for a vehicle protecting film using a compound composition according to one embodiment of the present invention.

FIGS. 4A, 4B, 4C and 4D schematically show results on test #1 of polishing the compound composition according to one embodiment of the present invention.

FIGS. 5A, 5B, 5C and 5D schematically show results on test #2 of polishing the compound composition according to one embodiment of the present invention.

FIGS. 6A, 6B, 6C and 6D schematically show results on test #3 of polishing the compound composition according to one embodiment of the present invention.

FIG. 7 schematically shows a state in which the vehicle protecting film is restored using the compound composition according to one embodiment of the present invention.

### DETAILED DESCRIPTION OF THE INVENTION

Hereinafter, various embodiments and/or aspects will be described with reference to the drawings. In the following description, numerous specific details are set forth in order to provide a thorough understanding of one or more aspects for the purpose of explanation. However, it will also be appreciated by a person having ordinary skill in the art that such aspect(s) may be carried out without the specific details. The following description and accompanying drawings will be set forth in detail for specific illustrative aspects among one or more aspects. However, the aspects are merely illustrative and some of various ways among principles of the various aspects may be employed, and the descriptions set forth herein are intended to include all the various aspects and equivalents thereof.

The term “embodiment”, “example”, “aspect”, “exemplification”, or the like as used herein may not be construed in that an aspect or design set forth herein is preferable or advantageous than other aspects or designs.

Further, the term “or” is intended to signify an inclusive “or” rather than an exclusive “or”. In other words, unless otherwise specified or contextually unclear, the expression “X uses A or B” is intended to signify one of natural inclusive substitutions. In other words, when X uses A; X uses B; or X uses both A and B, the expression “X uses A or B” may apply to either of the above cases. In addition, it is apparent to be understood that the term “and/or” as used herein refers to and includes all possible combinations of one or more among related items listed.

In addition, the terms “include” and/or “comprise” specify the presence of the corresponding feature and/or component, but do not preclude the possibility of the presence or addition of one or more other features, components or combinations thereof.

In addition, it will be understood that singular expressions such as “one” and “the”, unless explicitly indicated otherwise in this specification, include plural expressions. Accordingly, for example, “component surface” includes one or more component surfaces.

In addition, the terms including an ordinal number such as first and second may be used to describe various elements, however, the components are not limited by the terms. The terms are used only for the purpose of distinguishing one component from another component. For example, the first component may be referred to as the second component without departing from the scope of the present invention, and similarly, the second component may also be referred to as the first component. The term “and/or” includes any one of a plurality of related listed items or a combination thereof.

In addition, the term used herein is merely for the purpose of illustrating a particular embodiment, and it is not intended to limit the present invention. The singular expression includes a plural expression unless the context clearly means otherwise. In the specification herein, it will be understood that the term such as “include” and “have” is intended to designate the presence of feature, number, step, operation, element, combination thereof recited in the specification, which does not preclude the possibility of the presence or addition of one or more other features, numbers, steps, operations, elements, components, or combinations thereof.

In addition, in embodiments of the present invention, unless defined otherwise, all terms used herein including technical or scientific terms have the same meaning as commonly understood by a person having ordinary skill in the art. Terms such as those defined in generally used dictionaries will be interpreted to have the meaning consistent with the meaning in the context of the related art, and will not be interpreted as an ideal or excessively formal meaning unless expressly defined in the embodiment of the present invention.

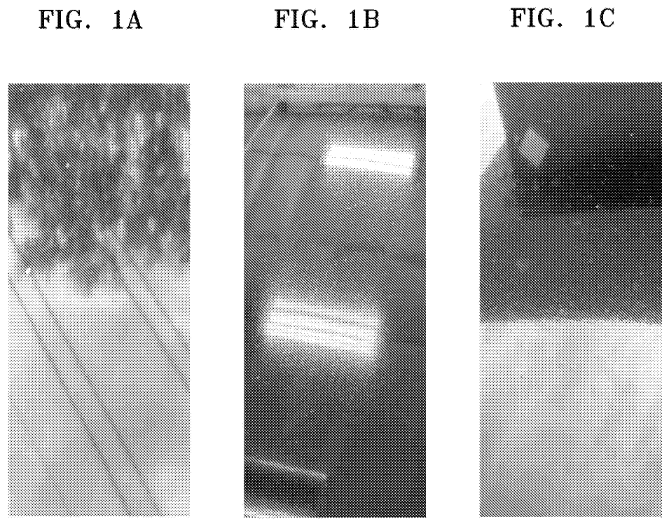

FIGS. 1A, 1B and 1C show states in which damages occur to a vehicle protecting film as an example.

The vehicle protecting film may correspond to a wrapping film, PPF, or the like.

After the vehicle protecting film is installed on the vehicle, the vehicle protecting film (hereinafter, the vehicle protecting film) may have a surface in which damages such as water spots or scratches as shown in FIGS. 1A, 1B, and 1C are generated depending on usage environments.

Since there is not a managing solution specialized for a vehicle protecting film in the related art, the damaged vehicle protecting film is removed and re-installed to remove the damage, however, as a result, the burden on consumers has been gradually increased. Recently, schemes of applying a compound to a surface of a vehicle protecting film and then polishing the surface by using a pad have been attempted to reduce the burden on consumers.

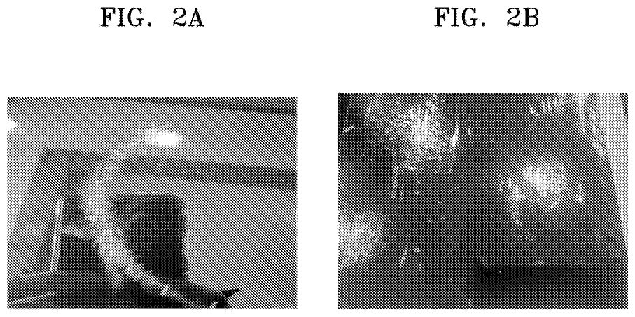

FIGS. 2A and 2B schematically show states in which the vehicle protecting film is polished using a conventional compound.

FIG. 2A is a picture of a surface of a vehicle protecting film polished using #3000 compound of 3M Company, FIG. 2B is a picture of a surface of a vehicle protecting film polished using #105 of McGuire Company.

As shown in FIG. 2A to FIG. 2B, it is confirmed that, when the surface of the vehicle protecting film is polished using the conventional compounds, the surface of the vehicle protecting film is damaged, such as being locally lifted, pushed or burned. This is because the vehicle protecting film has a self-restoration layer that is vulnerable to heat. Although the compound is required to be prevented from being evaporated during polishing work to protect the self-restoration layer, the conventional compounds are evaporated too quickly during the polishing work, and accordingly, only the abrasive ingredients remain, thereby causing a damage to the self-restoration layer.

In general, heat generated during the polishing work may increase a surface temperature of the vehicle protecting film to 85° C. to 95° C.

In other words, in order to polish the surface of the vehicle protecting film using a compound to remove the damage, it is necessary to use a compound composition capable of protecting a self-restoration layer of a vehicle protecting film from heat generated during polishing work.

According to the present invention in order to solve the above-described problems in the related art, a lubricant having an evaporation point of 150° C. or higher is added to a compound composition.

More specifically, the present invention relates to a compound composition for restoring a vehicle protecting film, which includes an abrasive, a lubricant and a solvent as a whole, and the lubricant has a feature of having an evaporation point of 150° C. or higher. Due to the feature, the compound composition of the present invention may remain on the surface of the vehicle protecting film even during polishing work, so that the surface of the vehicle protecting film can be prevented from being damaged.

In other words, the present invention may provide a compound composite for restoring a protecting film for a vehicle in which a lubricant having an evaporation point of 150° C. or higher is added to evaporate the compound composition at an appropriate rate during polishing work, so that the protecting film for the vehicle can be restored without a damage.

Hereinafter, a compound composition according to one embodiment of the present invention will be described in detail.

### Compound Composition

A compound composite for restoring a protecting film for a vehicle according to one embodiment of the present invention includes: an abrasive containing metal oxide powder; a lubricant having an evaporation point of 150° C. or higher; and a solvent containing water.

The abrasive corresponds to a material capable of polishing a surface of a vehicle protecting film or a surface of a self-restoration layer of the vehicle protecting film.

When the compound composition is applied to the surface of the vehicle protecting film, metal oxide powder contained in the abrasive may come into contact with the surface of the vehicle protecting film. In this state, when the user buffs while spreading the compound composition by using a pad described later, the surface of the vehicle protecting film may be directly polished.

The metal oxide powder according to one embodiment of the present invention may include any one of aluminum oxide and silicon carbide.

Meanwhile, it is common for abrasives to name a particle size by using the ANSI (Grit) standard, and grits are attached to the ANSI numbers. The grit is a unit expressing how many particles (metal oxide powder) are contained per inch, and the particle size contained in the abrasive is smaller when the number is higher.

The abrasive according to one embodiment of the present invention may include, based on ANSI (Grit) standards: a first abrasive having a particle size of 1400 grits to 2800 grits or a particle size of 4000 grits to 6000 grits; and a second abrasive having a particle size of 2800 grits to 3350 grits. The first abrasive may preferably have a particle size of 1400 grits to 2800 grits, or have a particle size of 4000 grits to 6000 grits, depending on a step in which the compound composition is applied during the restoration process described later.

For example, the first abrasive may have a particle size of 1400 grits to 2800 grits (more preferably have a particle size of 2000 grits) when the compound composition is applied in the first compound polishing step, and have a particle size of 4000 grits to 6000 grits (more preferably have a particle size of 5000 grits) when the compound composition is applied in the second compound polishing step. In other words, the compound composition used in the first compound polishing step has a first abrasive having a larger particle size compared to the compound composition used in the second compound polishing step.

The compound composition contains an abrasive having a specific particle size as above, so as to evenly polish the surface of the vehicle protecting film, so that the completion of the polishing work can be improved.

Preferably, the compound composition according to one embodiment of the present invention may include 10 wt % to 20 wt % of an abrasive based on a total weight.

The composition range of the abrasive corresponds to a range capable of polishing all damage such as scratches generated on the surface of the vehicle protecting film. In other words, the abrasive is composed of the above composition, so that a solution capable of using the compound composition to polish and manage the surface of the vehicle protecting film can be provided.

Preferably, the compound composition may include 5 wt % to 15 wt % of a first abrasive, and 0.1 wt % to 10 wt % of a second abrasive, based on a total weight.

The above composition range of the first abrasive and the second abrasive corresponds to a range for removing all damage that is visibly checked and preventing a cause of non-glossy phenomenon. In other words, the abrasive includes the first abrasive and the second abrasive composed of the above composition, so that all damage generated on the surface of the vehicle protecting film can be removed using the compound composition, and excellent installation completion can be implemented in which the gloss of the vehicle protecting film is prevented from being damaged.

The lubricant corresponds to a material that controls the liquidus viscosity and the volatilization rate of the compound composition.

When the volatilization rate of the compound composition is improperly controlled, only abrasive ingredients may remain during polishing work. In this case, since the frictional force between the abrasive and the surface of the vehicle protecting film may be increased, the heat generation rate on the surface of the vehicle protecting film may be further increased. The surface temperature of the vehicle protecting film during the polishing work is 85 to 95° C., which is relatively lower than a melting point of TPU that is a major material of the vehicle protecting film. However, attention is required since the surface of the vehicle protecting film may be damaged by pressure and heat generated during the polishing work even when the temperature lasts only a few seconds.

In other words, according to the present invention, a lubricant is added to the compound composition, in which the lubricant has an evaporation point of 150° C. or higher, so as to prevent the compound composition from rapidly being evaporated and only the abrasive ingredients from remaining during polishing work. Preferably, the lubricant having an evaporation point of 150° C. or higher is added to the compound composition, and accordingly, the compound composition may remain on the surface of the vehicle protecting film even during polishing work, so that the surface of the vehicle protecting film can be prevented from being damaged.

The lubricant according to one embodiment of the present invention may include: a first lubricant having an evaporation point of 150° C. or higher; and a second lubricant having an evaporation point equal to or higher than the evaporation point of the first lubricant.

Preferably, the first lubricant may have an evaporation point of 150° C. or higher, and the second lubricant may have an evaporation point of 150° C. to 400° C. More preferably, the first lubricant may have an evaporation point of 150° C., and the second lubricant may have an evaporation point of 250° C.

In other words, the compound composition of the present invention includes a combination of a first lubricant and a second lubricant, and particularly contains a second lubricant having an evaporation point of 250° C., so that the vehicle protecting film can be effectively restored. Preferably, a combination of the first lubricant having an oil evaporation point of 150° C. and the second lubricant having an oil evaporation point of 250° C. may be added to the compound composition, so that the vehicle protecting film can be more effectively restored.

Preferably, the compound composition according to one embodiment of the present invention includes 15 wt % to 25 wt % of a lubricant based on a total weight. Preferably, the compound composition may include 15 wt % to 25 wt % of a first lubricant, and 0.5 wt % to 5 wt % of a second lubricant based on a total weight.

The above composition range of the lubricant corresponds to a range for controlling the liquidus viscosity and the volatilization rate of the compound composition to a predetermined range. In other words, the lubricant includes the first lubricant and the second lubricant configured to have the above composition, and accordingly, the phenomenon, in which only the abrasive of the compound composition remains while polishing the surface of the vehicle protecting film, may be prevented, so that excellent resilience can be realized.

The solvent, similarly to the lubricant, corresponds to a material for controlling the liquidus viscosity and the volatilization rate of the compound composition.

According to one embodiment of the present invention, since the solvent includes water, and the surface temperature of the vehicle protecting film during polishing work is 85° C. to 95° C., which is below the boiling point of water as described above, the evaporation rate of the compound composition can be controlled.

As in the above, water is used as a solvent for the compound composition in considering that the surface temperature of the vehicle protecting film during polishing work is about 90° C., so that the compound composition can be evaporated at an appropriate rate during the polishing work.

Preferably, the compound composition according to one embodiment of the present invention may include 45 wt % to 55 wt % of a solvent based on a total weight.

The above composition range of the solvent corresponds to a range for controlling the liquidus viscosity and the volatilization rate of the compound composition to a predetermined range. In other words, the solvent is composed of the above composition to prevent the phenomenon, in which only the abrasive of the compound composition remains while polishing the surface of the vehicle protecting film, so that excellent resilience can be realized.

Meanwhile, the compound composition may further include an additive.

Preferably, the additive may include: a first moisturizer containing glycerin; a solvent containing DPNB; a lubricating solvent containing castor oil; a thickener containing DR-; a second moisturizer; an emulsifying preservative containing morpholine; and an antiseptic containing SB-20.

More preferably, the additive may include: 3.5 wt % to 5.5 wt % of a first moisturizer; 1.5 wt % to 3.5 wt % of a solvent; 0.5 wt % to 2.5 wt % of a lubricating solvent; 0.5 wt % to 2.5 wt % of a thickener; 0.1 wt % to 1 wt % of a second moisturizer; 0.1 wt % to 0.3 wt % of an emulsifying preservative; and 0.1 wt % to 0.3 wt % of an antiseptic.

### Restoration Solution for Vehicle Protecting Film Using Compound Composition

The present invention provides a restoration solution for restoring a vehicle protecting film damaged on an upper side and including a self-restoration layer without separately replacing the vehicle protecting film. The restoration solution of the present invention polishes the upper side of the self-restoration layer by using the compound composition applied to the self-restoration layer and a polisher rotating in a circular manner.

Hereinafter, the restoration solution using the compound composition according to one embodiment of the present invention will be described in more detail.

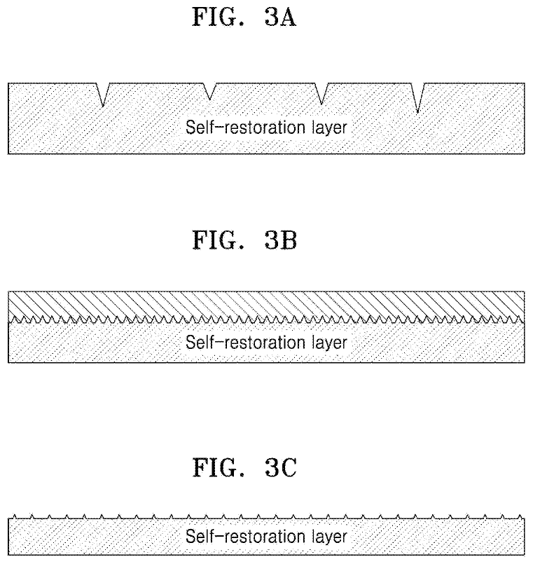

FIGS. 3A, 3B and 3C conceptually show a restoration solution for a vehicle protecting film using a compound composition according to one embodiment of the present invention.

As shown in FIG. 3A, the restoration solution is configured to target a self-restoration layer having an upper side in which damages including water spots and scratches are generated.

The restoration solution basically uses the compound composition according to one embodiment of the present invention. When a damaging material including a scratch digs into a surface of the self-restoration layer as shown in FIG. 3A, the compound composition is applied to the self-restoration layer and then the upper side of the self-restoration layer is polished using a pad as shown in FIG. 3B, so that the damaged portion may be removed.

The surface of the self-restoration layer may be polished to a damaged depth due to the damage including scratches. Preferably, when the vehicle protecting film includes a self-restoration layer in which a damage is generated on an upper side of the vehicle protecting film, the compound composition is applied to the self-restoration layer and then the upper side of the self-restoration layer is polished using a pad by a predetermined thickness, so that the damage may be removed.

Meanwhile, according to one embodiment of the present invention, FIG. 3B corresponds to performing the first compound polishing step.

In the first compound polishing step, since the compound composition containing the first abrasive having a relatively large particle size is applied as described above, a fine surface damage due to abrasive particles may occur on the surface of the self-restoration layer after the first compound polishing step, and accordingly, the non-glossy phenomenon may occur.

The restoration solution according to one embodiment of the present invention, after the first compound polishing step as shown in FIG. 3B, may polish the surface of the self-restoration layer by using a compound composition containing a first abrasive having a relatively small particle size compared to the first abrasive contained in the compound composition used in the first compound polishing step, thereby removing the fine surface damage as shown in FIG. 3C, so that the non-glossy phenomenon confirmed with the naked eye can be removed.

In other words, according to one embodiment of the present invention, FIG. 3C corresponds to performing the second compound polishing step. The restoration solution polishes the surface of the vehicle protecting film by using the compound composition, and even removes a damage generated during polishing, so that the vehicle protecting film can be restored.

Hereinafter, tests are conducted on whether the surface of the vehicle protecting film was polished without a damage by using the compound composition according to one embodiment of the present invention. The results will be described in detail.

### Test #1 on Polishing Vehicle Protecting Film by Using Compound Composition

This test is designed to confirm whether the compound composition polishes the surface of the vehicle protecting film without a damage, while the compound composition according to the embodiments of the present invention contains a second lubricant having an oil evaporation point of 150° C.

Specifically, in this test, four compound compositions according to one embodiment of the present invention, which differ only in the content of the second lubricant having an oil evaporation point of 150° C., are prepared. After each of the four compound compositions is applied to a surface of the vehicle protecting film, heat is repeatedly applied at 90° C. for 2 hours in considering that the surface temperature of the vehicle protecting film rises to 85° C. to 95° C. during polishing work. It is confirmed with naked eyes whether oil ingredients of the compound composition remain after the heat is applied.

The four compound compositions according to the embodiments of the present invention correspond to the compound compositions having following combinations, respectively.

### Example 1

A compound composition including 10 wt % of a first abrasive, 4.5 wt % of a second abrasive, 20 wt % of a first lubricant, 0.5 wt % of a second lubricant, 51.97 wt % of a solvent, and 11.03 wt % of an additive, based on a total weight.

### Example 2

A compound composition including 10 wt % of a first abrasive, 4.5 wt % of a second abrasive, 20 wt % of a first lubricant, 1 wt % of a second lubricant, 51.97 wt % of a solvent, and 11.03 wt % of an additive, based on a total weight.

### Example 3

A compound composition including 10 wt % of a first abrasive, 4.5 wt % of a second abrasive, 20 wt % of a first lubricant, 1.5 wt % of a second lubricant, 51.97 wt % of a solvent, and 11.03 wt % of an additive, based on a total weight.

### Example 4

A compound composition including 10 wt % of a first abrasive, 4.5 wt % of a second abrasive, 20 wt % of a first lubricant, 2 wt % of a second lubricant, 51.97 wt % of a solvent, and 11.03 wt % of an additive, based on a total weight.

The first lubricants of Examples 1 to 4 correspond to lubricants having an oil evaporation point of 150° C., and the second lubricants of Examples 1 to 4 correspond to lubricants having an oil evaporation point of 150° C. like the first lubricants but it is preferable to be different from products of manufacturers of the first lubricants.

In addition, it is preferable that all of the additives of Examples 1 to 4 are composed of ingredients and combinations corresponding to each other.

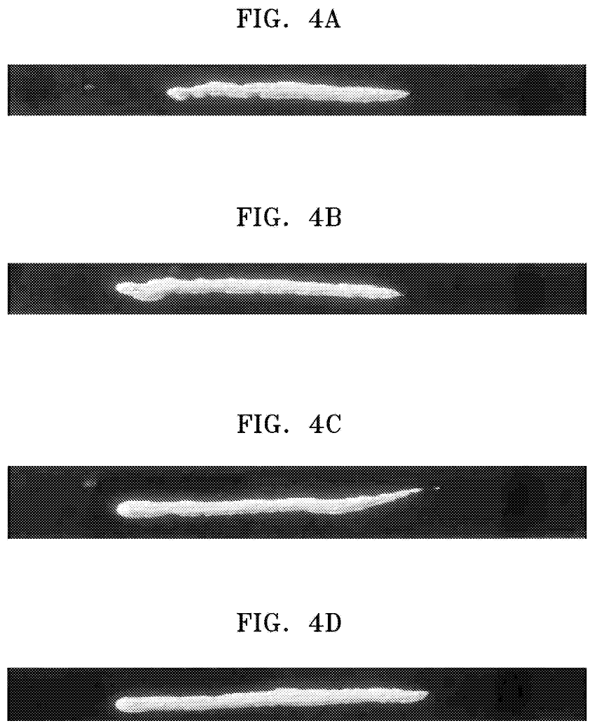

FIGS. 4A, 4B, 4C and 4D schematically show results on test #1 of polishing the compound composition according to one embodiment of the present invention.

FIG. 4A is a photograph of a vehicle protecting film after applying Example 1 and applying heat to the surface. As shown in FIG. 4A, it can be seen that Example 1 indicates that no oil ingredient remains after the heat is applied.

FIG. 4B is a photograph of a vehicle protecting film after applying Example 2 and applying heat to the surface. As shown in FIG. 4B, it can be seen that Example 2 indicates that no oil ingredient remains after the heat is applied.

FIG. 4C is a photograph of a vehicle protecting film after applying Example 3 and applying heat to the surface. As shown in FIG. 4C, it can be seen that Example 3 indicates that no oil ingredient remains after the heat is applied.

FIG. 4D is a photograph of a vehicle protecting film after applying Example 4 and applying heat to the surface. As shown in FIG. 4D, it can be seen that Example 4 indicates that no oil ingredient remains after the heat is applied.

The absence of oil ingredients after applying heat signifies that the compound composition is quickly evaporated during polishing work, and accordingly the surface of the vehicle protecting film may be damaged.

In other words, it is confirmed through Test #1 that, when the surface of the vehicle protecting film is polished by using the compound composition in which the combination of the first lubricant having an oil evaporation point of 150° C. and the second lubricant having an oil evaporation point of 150° C. is added, the compound composition is quickly evaporated during polishing work, and accordingly the self-restoration layer of the vehicle protecting film may be damaged.

### Test #2 on Polishing Vehicle Protecting Film by Using Compound Composition

This test is designed to confirm whether the compound composition polishes the surface of the vehicle protecting film without a damage, while the compound composition according to the embodiments of the present invention contains a second lubricant having an oil evaporation point of 200° C.

Specifically, in this test, four compound compositions according to one embodiment of the present invention, which differ only in the content of the second lubricant having an oil evaporation point of 200° C., are prepared. After each of the four compound compositions is applied to a surface of the vehicle protecting film, heat is repeatedly applied at 90° C. for 2 hours in considering that the surface temperature of the vehicle protecting film rises to 85° C. to 95° C. during polishing work. It is confirmed with naked eyes whether oil ingredients of the compound composition remain after the heat is applied.

The four compound compositions according to the embodiments of the present invention correspond to the compound compositions having following combinations, respectively.

### Example 5

A compound composition including 10 wt % of a first abrasive, 4.5 wt % of a second abrasive, 20 wt % of a first lubricant, 0.5 wt % of a second lubricant, 51.97 wt % of a solvent, and 11.03 wt % of an additive, based on a total weight.

### Example 6

A compound composition including 10 wt % of a first abrasive, 4.5 wt % of a second abrasive, 20 wt % of a first lubricant, 1 wt % of a second lubricant, 51.97 wt % of a solvent, and 11.03 wt % of an additive, based on a total weight.

### Example 7

A compound composition including 10 wt % of a first abrasive, 4.5 wt % of a second abrasive, 20 wt % of a first lubricant, 1.5 wt % of a second lubricant, 51.97 wt % of a solvent, and 11.03 wt % of an additive, based on a total weight.

### Example 8

A compound composition including 10 wt % of a first abrasive, 4.5 wt % of a second abrasive, 20 wt % of a first lubricant, 2 wt % of a second lubricant, 51.97 wt % of a solvent, and 11.03 wt % of an additive, based on a total weight.

The first lubricants of Examples 5 to 8 correspond to lubricants having an oil evaporation point of 150° C., and the second lubricants of Examples 5 to 8 correspond to lubricants having an oil evaporation point of 200° C.

In addition, it is preferable that all of the additives of Examples 5 to 8 are composed of ingredients and combinations corresponding to each other.

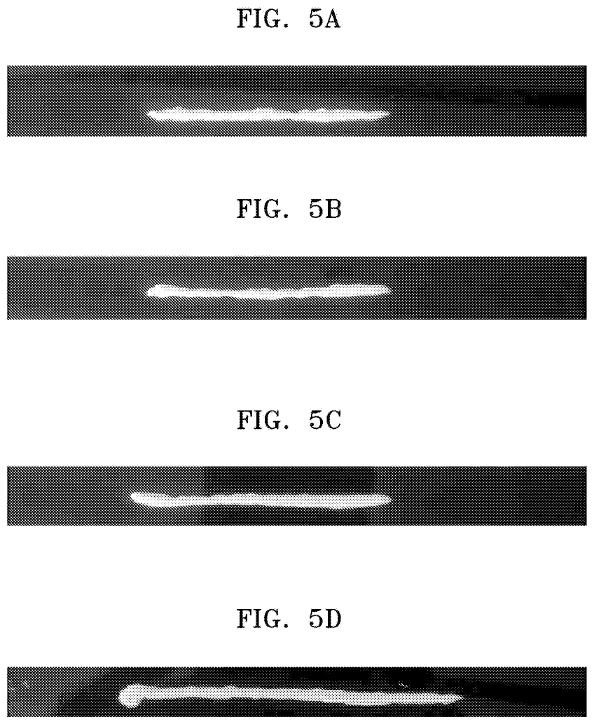

FIGS. 5A, 5B, 5C and 5D schematically show results on test #2 of polishing the compound composition according to one embodiment of the present invention.

FIG. 5A is a photograph of a vehicle protecting film after applying Example 5 and applying heat to the surface. As shown in FIG. 5A, it can be seen that Example 5 indicates that no oil ingredient remains after the heat is applied.

FIG. 5B is a photograph of a vehicle protecting film after applying Example 6 and applying heat to the surface. As shown in FIG. 5B, it can be seen that Example 6 indicates that no oil ingredient remains after the heat is applied.

FIG. 5C is a photograph of a vehicle protecting film after applying Example 7 and applying heat to the surface. As shown in FIG. 5C, it can be seen that Example 7 indicates that no oil ingredient remains after the heat is applied.

FIG. 5D is a photograph of a vehicle protecting film after applying Example 8 and applying heat to the surface. As shown in FIG. 5D, it can be seen that Example 8 indicates that a relatively weak oil trace remains after the heat is applied.

As described above, the absence of oil ingredients after applying heat signifies that the compound composition is quickly evaporated during polishing work, and accordingly the surface of the vehicle protecting film may be damaged.

The presence of oil ingredients after applying heat signifies that the compound composition is not evaporated quickly but evaporated at an appropriate rate during the polishing work, and this signifies that the self-restoration layer of the vehicle protecting film is restored without being damaged by the polishing work.

Considering this, it is confirmed through Test #2 that, when the compound composition obtained by adding the combination of the first lubricant having an oil evaporation point of 150° C. and the second lubricant having an oil evaporation point of 200° C. is used according to an embodiment of the present invention, and when less than 2 wt % of the second lubricant is contained, the compound composition is quickly evaporated during polishing work, and accordingly the self-restoration layer of the vehicle protecting film may be damaged. However, when 2 wt % or higher of the second lubricant is contained, the surface of the vehicle protecting film may be polished without a damage.

### Test #3 on Polishing Vehicle Protecting Film by Using Compound Composition

This test is designed to confirm whether the compound composition polishes the surface of the vehicle protecting film without a damage, while the compound composition according to the embodiments of the present invention contains a second lubricant having an oil evaporation point of 250° C.

Specifically, in this test, four compound compositions according to one embodiment of the present invention, which differ only in the content of the second lubricant having an oil evaporation point of 250° C., are prepared. After each of the four compound compositions is applied to a surface of the vehicle protecting film, heat is repeatedly applied at 90° C. for 2 hours in considering that the surface temperature of the vehicle protecting film rises to 85° C. to 95° C. during polishing work. It is confirmed with naked eyes whether oil ingredients of the compound composition remain after the heat is applied.

The four compound compositions according to the embodiments of the present invention correspond to the compound compositions having following combinations, respectively.

### Example 9

A compound composition including 10 wt % of a first abrasive, 4.5 wt % of a second abrasive, 20 wt % of a first lubricant, 0.5 wt % of a second lubricant, 51.97 wt % of a solvent, and 11.03 wt % of an additive, based on a total weight.

### Example 10

A compound composition including 10 wt % of a first abrasive, 4.5 wt % of a second abrasive, 20 wt % of a first lubricant, 1 wt % of a second lubricant, 51.97 wt % of a solvent, and 11.03 wt % of an additive, based on a total weight.

### Example 11

A compound composition including 10 wt % of a first abrasive, 4.5 wt % of a second abrasive, 20 wt % of a first lubricant, 1.5 wt % of a second lubricant, 51.97 wt % of a solvent, and 11.03 wt % of an additive, based on a total weight.

### Example 12

A compound composition including 10 wt % of a first abrasive, 4.5 wt % of a second abrasive, 20 wt % of a first lubricant, 2 wt % of a second lubricant, 51.97 wt % of a solvent, and 11.03 wt % of an additive, based on a total weight.

The first lubricants of Examples 9 to 12 correspond to lubricants having an oil evaporation point of 150° C., and the second lubricants of Examples 9 to 12 correspond to lubricants having an oil evaporation point of 250° C.

In addition, it is preferable that all of the additives of Examples 9 to 12 are composed of ingredients and combinations corresponding to each other.

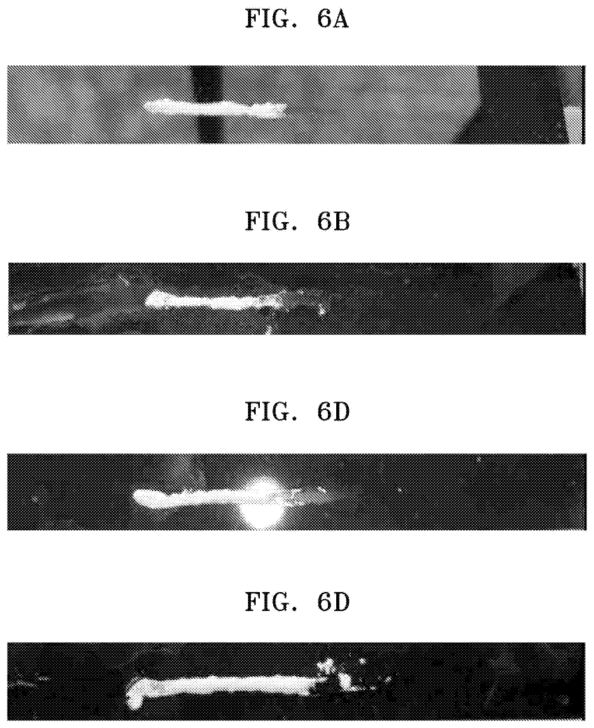

FIGS. 6A, 6B, 6C and 6D schematically show results on test #3 of polishing the compound composition according to one embodiment of the present invention.

FIG. 6A is a photograph of a vehicle protecting film after applying Example 9 and applying heat to the surface. As shown in FIG. 6A, it can be seen that Example 9 indicates that no oil ingredient remains after the heat is applied.

FIG. 6B is a photograph of a vehicle protecting film after applying Example 10 and applying heat to the surface. As shown in FIG. 6B, it can be seen that Example 10 indicates that a relatively weak oil trace remains after the heat is applied.

FIG. 6C is a photograph of a vehicle protecting film after applying Example 11 and applying heat to the surface. As shown in FIG. 6C, it can be seen that Example 11 indicates that oil residues remain after the heat is applied.

FIG. 6D is a photograph of a vehicle protecting film after applying Example 12 and applying heat to the surface. As shown in FIG. 6D, it can be seen that Example 12 indicates that oil residues remain after the heat is applied.

As described above, the absence of oil ingredients after applying heat signifies that the compound composition is quickly evaporated during polishing work, and accordingly the surface of the vehicle protecting film may be damaged.

Meanwhile, the presence of oil ingredients after applying heat signifies that the compound composition is not evaporated quickly but evaporated at an appropriate rate during the polishing work, and this signifies that the self-restoration layer of the vehicle protecting film is restored without being damaged by the polishing work.

Considering this, it is confirmed through Test #3 that, when the compound obtained by adding the combination of the first lubricant having an oil evaporation point of 150° C. and the second lubricant having an oil evaporation point of 250° C. is used according to an embodiment of the present invention, and when 0.5 wt % of the second lubricant is contained, the compound composition is quickly evaporated during polishing work, and accordingly the self-restoration layer of the vehicle protecting film may be damaged. However, when more than 0.5 wt % of the second lubricant is contained, the surface of the vehicle protecting film may be polished without a damage.

More particularly, it can be determined that Examples 11 and 12, in which oil residues are relatively clearly confirmed compared to the above-described Test #2, can more effectively prevent the surface of the vehicle protecting film from being damaged during the polishing work.

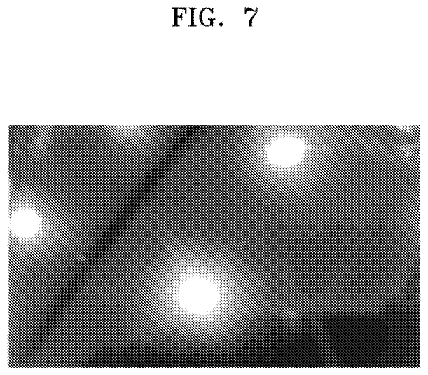

FIG. 7 schematically shows a state in which the vehicle protecting film is restored using the compound composition according to one embodiment of the present invention.

As confirmed in the above-described FIGS. 4 to 6, the compound composition according to one embodiment of the present invention may be used stably even when being left in heat generated for a long time during the polishing work, so that the vehicle protecting film can be managed, such as polishing, without a damage on the surface thereof.

In other words, when the compound composition is used, the damage to the vehicle protecting film can be removed without damaging the surface of the vehicle protecting film. More particularly, as shown in FIG. 7, it can be confirmed that the non-glossy phenomenon due to polishing work does not occur on the surface of the vehicle protecting film, and the vehicle protecting film can be restored to have a gloss similar to that at the time of initially installing the vehicle protecting film.

The compound composition may preferably include a combination of a first lubricant having an oil evaporation point of 150° C. and a second lubricant having an oil evaporation point of 150° C. to 400° C. It is more preferable that the second lubricant has an oil evaporation point of 250° C. or higher.

One embodiment of the present invention may provide a compound composite for restoring a protecting film for a vehicle in which a lubricant having an evaporation point of 150° C. or higher is added to evaporate the compound composition at an appropriate rate during polishing work, so that the vehicle protecting film for a vehicle can be restored without a damage.

According to one embodiment of the present invention, water is used as a solvent for the compound composition in considering that the surface temperature of the vehicle protecting film during polishing work is about 90° C., so that the compound composition can be evaporated at an appropriate rate during the polishing work.

According to one embodiment of the present invention, a lubricant having an evaporation point of 150° C. or higher is added to the compound composition, and accordingly, the compound composition may remain on the surface of the vehicle protecting film even during polishing work, so that the surface of the vehicle protecting film can be prevented from being damaged.

According to one embodiment of the present invention, the compound composition includes an abrasive having a specific particle size so as to evenly polish the surface of the vehicle protecting film, so that the completion of the polishing work can be improved.

According to one embodiment of the present invention, a combination of a first lubricant having an oil evaporation point of 150° C. and a second lubricant having an oil evaporation point of 250° C. is added to the compound composition, so that the vehicle protecting film can be more effectively restored.

According to one embodiment of the present invention, the compound composition includes a second lubricant having an oil evaporation point of 200° C. or higher so as to be used stably even when being left in heat generated for a long time during the polishing work, so that the vehicle protecting film can be managed, such as polishing, without a damage on the surface.

The descriptions of the described embodiments are provided to enable any person having ordinary skill in the art to use or execute the present invention. It will be apparent to the person having ordinary skill in the art that various modifications are available for the embodiments, and general principles defined herein may be applied to other embodiments without departing from the scope of the present invention. Accordingly, the present invention will not be limited to the embodiments set forth herein but will be construed in the broadest scope consistent with the principles and novel features set forth herein.

What is claimed is:

1. A compound composite for restoring a vehicle protecting film, the compound composite comprising:
an abrasive containing metal oxide powder;
a lubricant having an evaporation point of 150° C. or higher; and
a solvent containing water, wherein,
when the vehicle protecting film includes a self-restoration layer in which a damage is generated on an upper side of the vehicle protecting film, the compound composition is applied to the self-restoration layer and then the upper side of the self-restoration layer is polished using a pad by a predetermined thickness, thereby removing the damage.

2. The compound composition of claim 1, wherein the abrasive based on ANSI (Grit) standards includes:
a first abrasive having a particle size of 1400 grits to 2800 grits or a particle size of 4000 grits to 6000 grits; and
a second abrasive having a particle size of 2800 grits to 3350 grits.

3. The compound composition of claim 1, wherein
the lubricant includes:
a first lubricant having an evaporation point of 150° C. or higher; and
a second lubricant having an evaporation point equal to or higher than the evaporation point of the first lubricant.

4. The compound composition of claim 3, wherein the second lubricant has an evaporation point of 150° C. to 400° C.

5. The compound composition of claim 1, wherein the metal oxide powder includes any one of aluminum oxide and silicon carbide.

6. The compound composition of claim 1, wherein the compound composition includes 10 wt % to 20 wt % of an abrasive, 15 wt % to 25 wt % of a lubricant, and 45 wt % to 55 wt % of a solvent, based on a total weight.
